(19) United States
(12) Patent Application Publication
(10) Pub. No.: US 2017/0061224 A1
(43) Pub. Date: Mar. 2, 2017

(54) DEVICES AND METHODS INCLUDING BARE FEET IMAGES FOR WEIGHT MEASUREMENT

(71) Applicant: Sony Mobile Communications Inc., Lund (SE)

(72) Inventors: Olivier Moliner, Lund (SE); Erik Westenius, Stockholm (SE); Magnus Midholt, Lund (SE); Ola Thörn, Lund (SE)

(21) Appl. No.: 14/837,315

(22) Filed: Aug. 27, 2015

(51) Int. Cl. G06K 9/00; G06F 3/041; G06F 17/30; H04N 7/18; G01G 19/50; G06F 21/32

(52) U.S. Cl. CPC G06K 9/00892; G01G 19/50; G06F 21/32; G06F 17/30312; G06F 17/3028; H04N 7/18; G06F 3/041; G06K 9/00362

(57) ABSTRACT

A device for weighing a user includes a weight sensor that determines a weight of the user, and a bare feet image sensor that generates an image of the bare feet of the user. The device includes a processor that is responsive to the weight sensor and to the bare feet image sensor and executes computer program instructions to perform operations such as identifying a provisioned user out of one or more provisioned users based on the image of the bare feet of the user standing on the device. A database stores information associated with the image of the bare feet of one or more provisioned users of the device. The weight of the user associated with the identified provisioned is stored. Related devices and methods are provided.

### TECHNICAL FIELD

The present inventive concepts generally relate to the field of weight measurement, more specifically, to image processing in conjunction with weight measurement.

### BACKGROUND

Weigh scales have been used historically by users for obtaining weight measurements. However, due to increased health consciousness, a need has arisen to track and analyze weight measurements. Weigh scales may be used by multiple users in homes, offices, and medical facilities. Weight measurements of multiple users of a weigh scale need to be properly stored for each individual user and analyzed in order to make health assessments and recommendations.

### SUMMARY

Various embodiments described herein relate to devices and methods for obtaining a weight measurement of a user and more specifically, to utilize bare feet images for weight measurement.

Some embodiments of the present inventive concepts are directed to a device for determining the weight of a user. The device may include a weigh scale. The device may include a weight sensor configured to determine the weight of the user, a bare feet image sensor configured to generate an image of the bare feet of the user, and a database configured to store information associated with an image of the bare feet of one or more provisioned users of the device. The device may include a processor that is responsive to the weight sensor and to the bare feet image sensor and is configured to execute computer program instructions to perform operations including identifying a provisioned user out of one or more provisioned users in the database based on the image of the bare feet of the user, and/or storing the weight of the user in association with the provisioned user in the database.

According to various embodiments, identifying the provisioned user may be further based on the weight of the user. The device may include a body fat measurement sensor configured to determine body fat of the user. Identifying the provisioned user may include identifying the provisioned user out of one or more provisioned users based on the image of the bare feet of the user, the weight of the user, and the body fat of the user. The bare feet image sensor may include a capacitive touch-sensitive sensor on the weight sensor. The device may include a display. The capacitive touch-sensitive sensor may partially overlap the weight sensor and may not overlap the display. The bare feet image sensor may provide a notification to the user in response to determining that the feet of the user are not properly positioned on the bare feet image sensor.

According to various embodiments, the device may determine a distribution of the weight including a first portion of the weight on a first foot and a second portion of the weight on a second foot of the bare feet of the user. An indication may be provided to the user in response to a difference in the first portion and the second portion of the weight exceeding a threshold. The distribution of the weight may be based on information from the weight sensor and information from the bare feet image sensor.

According to various embodiments, a database may store information associated with the provisioned users. The information associated with the provisioned users of the device may include stored information associated with a respective one of the one or more provisioned users corresponding to a shape of the bare feet, an orientation of a first foot and a second foot of the bare feet, a weight of the user, and/or a body fat of the respective provisioned users. In various embodiments, identifying a provisioned user out of the one or more provisioned users based on the image of the bare feet of the user may include determining shape information corresponding to a shape of the bare feet of the user based on the image of the bare feet and/or selecting a provisioned user based on a comparison of the shape information and the stored information corresponding to the provisioned users. In various embodiments, identifying a provisioned user out of the one or more provisioned users based on the image of the bare feet of the user may include determining orientation information of a first foot and a second foot of the bare feet based on the image of the bare feet of the user and/or selecting a provisioned user based on a comparison of the orientation information and the stored information. According to various embodiments, the device may include an internet communication circuit configured to provide communication network connectivity between the device and an Internet of Things (IoT) network.

According to various embodiments, a multifactor authentication device for authenticating a user of an electronic device may include a weight sensor configured to determine a weight of the user, a bare feet image sensor configured to generate an image of the bare feet of the user on the multifactor authentication device, and/or a database configured to store information associated with an image of the bare feet of a plurality of provisioned users. The multifactor authentication device may include a processor that is responsive to the weight sensor and to the bare feet image sensor and is configured to execute computer program instructions to perform operations including authenticating the user to access the electronic device based on the weight of the user and the image of the bare feet of the user on the multifactor authentication device.

According to various embodiments, the multifactor authentication device may include a body fat measurement sensor configured to determine body fat of the user on the multifactor authentication device. Authenticating the user may include authenticating the user based on the image of the bare feet of the user, the weight of the user, and the body fat of the user. According to various embodiments, the multifactor authentication device may include a housing that includes a first face and a second face opposing the first face. The first face of the housing may be configured for placement on a horizontal surface. The weight sensor may be in the housing between the first face and the second face. The bare feet image sensor may be on the second face of the housing.

Some embodiments of the present inventive concepts are directed to a method for weighing a user on a weigh scale. The method may include determining a weight of the user, generating an image of the bare feet of the user on the weigh scale, and/or identifying a provisioned user out of one or more provisioned users, based on the image of the bare feet of the user on the weigh scale and information stored in a database that is associated with an image of the bare feet of the one or more provisioned users of the weigh scale, and/or storing the weight of the user associated with the provisioned user. The method may include determining a distribution of the weight including a first portion of the weight on a first foot and a second portion of the weight on a second foot of the bare feet of the user and/or providing an indication to the user in response to a difference in the first portion and the second portion of the weight exceeding a threshold. Information stored in the database may include stored information associated with a respective one of the one or more provisioned users corresponding to a shape of the bare feet, a weight of the user, and/or a body fat of the respective one of the one or more provisioned users. In various embodiments, identifying a provisioned user out of the one or more provisioned users based on the image of the bare feet of the user on the weigh scale may include determining shape information corresponding to a shape of the bare feet of the user based on the image of the bare feet, and/or selecting a provisioned user based on a comparison of the shape information and the stored information.

It is noted that aspects of the disclosure described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.,

### BRIEF DESCRIPTION OF THE DRAWINGS

Aspects of the present inventive concepts are illustrated by way of example and are not limited by the accompanying figures with like references indicating like elements.

FIGS. 1A and 1B illustrate a weigh scale, according to some embodiments of the present inventive concepts.

FIG. 2 is a block diagram illustrating devices/modules of the weigh scale of FIG. 1, according to some embodiments of the present inventive concepts.

FIGS. 3 to 6 are flowcharts of operations of any of FIGS. 1 and 2, that may be performed by a weigh scale, according to some embodiments of the present inventive concepts.

FIGS. 7A to 7D illustrate image processing techniques of bare feet, according to some embodiments of the present inventive concepts.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout. Numerous specific details are set forth in order to provide a thorough understanding of embodiments of the present inventive concepts. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As noted above, weigh scales are proliferating in homes, offices, and medical facilities in order to track health parameters such as weight and/or body fat. The prevalence of electronic health records and increasing network connected devices allow health records including weight and/or body fat to be stored in databases. Stored health parameters may be accessed by users and health professionals across a variety of platforms, used for historical data analysis for individual users, and/or for statistical trend analysis across a population. A device such as a weigh scale may be connected to a network for easier storage of health data, greater access to health data, and analysis of health data. As such, a weigh scale, as described by the present inventive concepts, may be embodied as an Internet of Things (IoT) device that is connected to a network.

The Internet of Things (IoT) is a network of physical objects or “things” that are uniquely identifiable and are embedded with communication network connectivity to enable them to achieve greater value and service by exchanging data with a user, operator, manufacturer, and/or other connected devices. IoT devices are proliferating across the world with the increase in use of technology, such as the Internet, virtualization, and cloud computing. IoT devices may include a variety of household appliances such as thermostats, power meters, water meters, refrigerators, washers/dryers, stoves, microwaves, dishwashers, toothbrushes, shavers, and/or televisions that include embedded network connectivity. IoT devices may also include a variety of other devices whose primary purpose is not network connectivity, but include embedded network connectivity such as medical devices including pacemakers, artificial limbs, casts and/or industrial devices such as motors, actuators, etc. A weigh scale may one such type of IoT device that is used by multiple users in a home, office, or medical facility.

Various embodiments described herein may arise from a recognition for a need to easily identify and distinguish multiple users of a weigh scale in a home, office, or medical facility. The multiple users need to be distinguished from one another in order to properly track each individual users' health parameters such as weight and/or body fat. According to various embodiments, individual users of the weigh scale may be identified based on an image of the bare feet of the user. Health data related to the identified users may be stored. According to various embodiments, the weigh scale may be used as a multifactor authentication device for authenticating a user based on health data such as weight, image of the bare feet, and/or body fat.

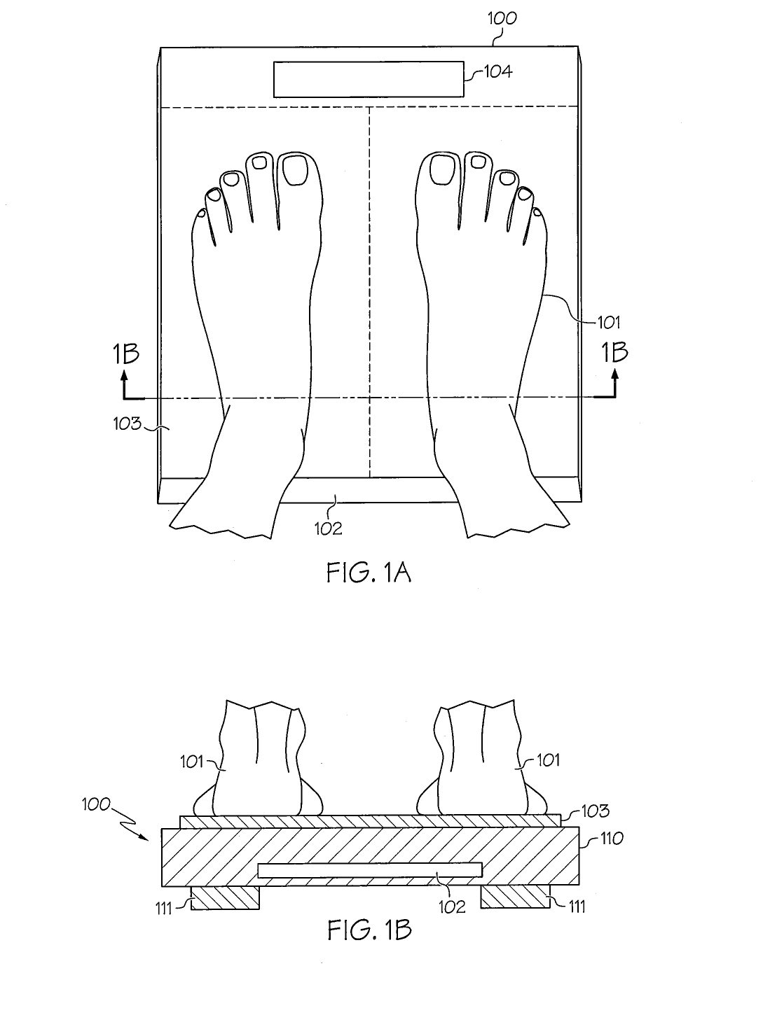

Referring now to FIG. 1, a weigh scale 100 is illustrated. The bare feet 101 of a user are on a weight sensor 102 of the weigh scale 100. The bare feet 101 of the user are in contact with a bare feet image sensor 103 that is on the weight sensor 102. The weigh scale 100 may include a display 104. The bare feet image sensor 103 may include a capacitive touch-sensitive sensor that at least partially overlaps the weight sensor 102 and does not overlap the display 104. As used herein, bare feet of a user may include direct skin contact to the bare feet image sensor as well as contact through thin socks or other perforated or non-perforated foot coverings that allow capacitive coupling between the feet of the user and the bare feet image sensor 103. Although the user is described herein as a human being, the weigh scale 100 may be used with other living things with feet such as cats or dogs. The weight sensor may include a strain gauge scale, a load cell scale, a mechanical measurement device such as spring scales, hydraulic scales, or pneumatic scales, balance scales, and/or elastica arm scales.

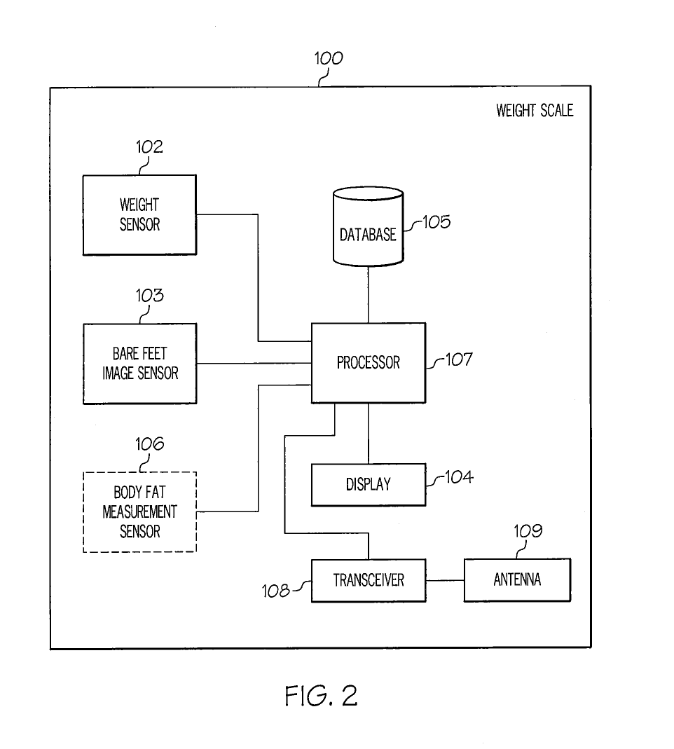

Referring now to FIG. 2, a block diagram including devices/modules of the weigh scale 100 of FIG. 1 is illustrated. The weigh scale 100 may include a weight sensor 102 that is configured to determine a weight of the user. The weigh scale 100 may include a bare feet image sensor 103 that is configured to generate an image of the bare feet of the user standing or otherwise in contact with the weigh scale 100. According to various embodiments, the bare feet image sensor 103 may provide a notification to the user in response to determining that the bare feet of the user are not properly positioned on the bare feet image sensor 103. The weigh scale 100 may detect that the user is wearing shoes if the weight sensor 102 detects a weight but the bare feet image sensor 103 do not recognize bare feet. In this case, an indication may be provided to the user to remove the shoes. The weight sensor 102 and the bare feet image sensor 103 may communicate with a processor 107. The processor 107 maybe responsive to the weight sensor 102 and the bare feet image sensor 103 and maybe configured to execute computer program instructions. The processor 107 may read and/or write data to a database 105. The database 105 may be a memory that is integrated with the processor, be separate from the processor, and/or remote from the processor and/or remote from the weigh scale 100. The database 105 may be remote from the weigh scale and accessible to the weigh scale 100 across a network. The processor 107 may perform operations to identify a provisioned user out of one or more provisioned users based on the image of the bare feet of the user standing on the weigh scale 100. The weight alone may not provide enough information to distinguish different users since several users may be of the same weight. However, attributes of the image of the bare feet, such as the shape of the feet, may be suitable for sufficiently distinguishing different users. More refined distinguishing between users may be possible using both the weight and the image of the bare feet.

Still referring to FIG. 2, according to various embodiments, the processor 107 may be coupled to a display 104 to provide indications to the user. According to various embodiments, the processor 107 may be coupled to a transceiver 108 that is coupled to an antenna 109. The transceiver 108 may include an internet communication circuit that is configured to provide communication network connectivity between the weigh scale 100 and a network such as, for example, an IoT network. The transceiver 108 and the antenna 109 may communicate externally to the weigh scale 100 using various protocols such as Wi-Fi, Bluetooth, etc. across a network to mobile devices such as smart phones or to a network operator or health data consolidator. The antenna 109 may be located within the housing of the weigh scale 100 or be external to the weigh scale 100.

Still referring to FIG. 2, according to various embodiments the weigh scale 100 may include a body fat measurement sensor 106. The body fat measurement sensor 106 may use bio electrical impedance to estimate the body fat of the user. The body fat measurement sensor 106 may pass a small electrical current into one foot of the bare feet of the user. The electrical current may travel up one leg of the user, across the pelvis of the user, and then down the other leg of the user. Due to higher water content, muscle may conduct electricity better than fat. The resulting measurement of the resistance of the body may indicate the amount of body fat of the user. The body fat measurement sensor 106 may be co-located with the bare feet image sensor 103 and may be above, below, or may function together with the bare feet image sensor 103.

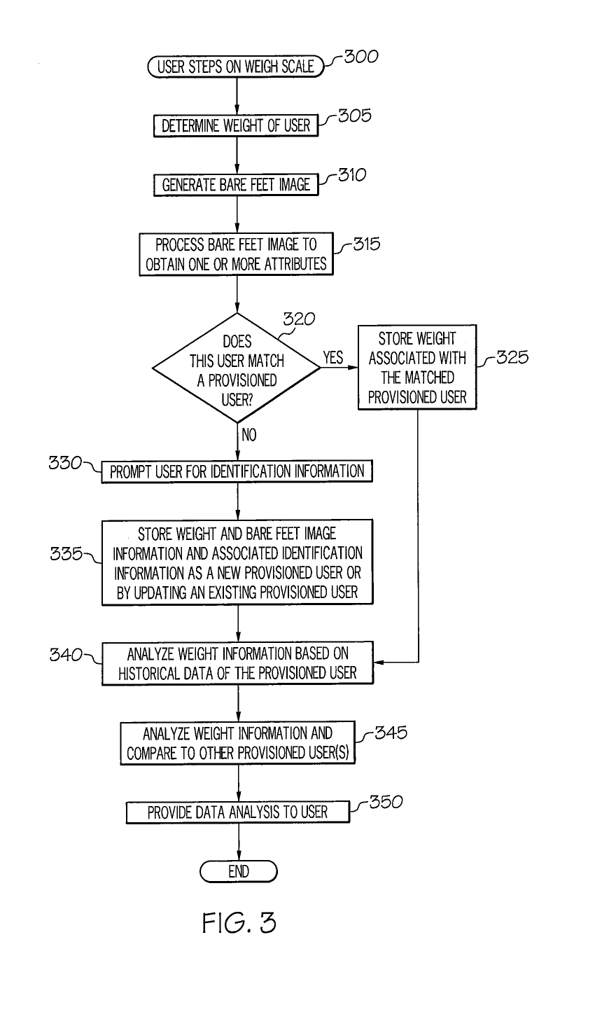

Referring to FIG. 3, a flowchart of operations that may be performed by the weigh scale of FIGS. 1 and 2 is illustrated. These operations may be executed by any of the modules of FIG. 2 and may be stored in memory 105 of FIG. 2 to be executed by processor circuit 107 of FIG. 2. At block 300, a user may step on the weigh scale 100 of FIGS. 1 and 2. The action of the user stepping on the weigh scale 100 may power on the weigh scale 100, awaken the weigh scale 100 from sleep mode, and/or activate the weigh scale 100. At block 305, the weight of the user may be determined by the weight sensor 102 of FIG. 2. The weight of the user may be determined in pounds, kilograms, or any other base units. The weight may be represented in the base units or may be converted using mathematical operations to a convenient unit such as, for example, binary representation, suitable for storage in memory in the weigh scale 100. At block 310, a bare feet image may be generated based on information from the bare feet image sensor 103 of FIG. 2. As discussed above with reference to FIG. 2, the bare feet image sensor 103 may include a capacitive touch-sensitive sensor that is sensitive to direct touch to the bare feet of a user and/or by close proximity to human skin, such as through socks or other thin coverings of the feet. The image of the bare feet may be represented by a grid of pixels.

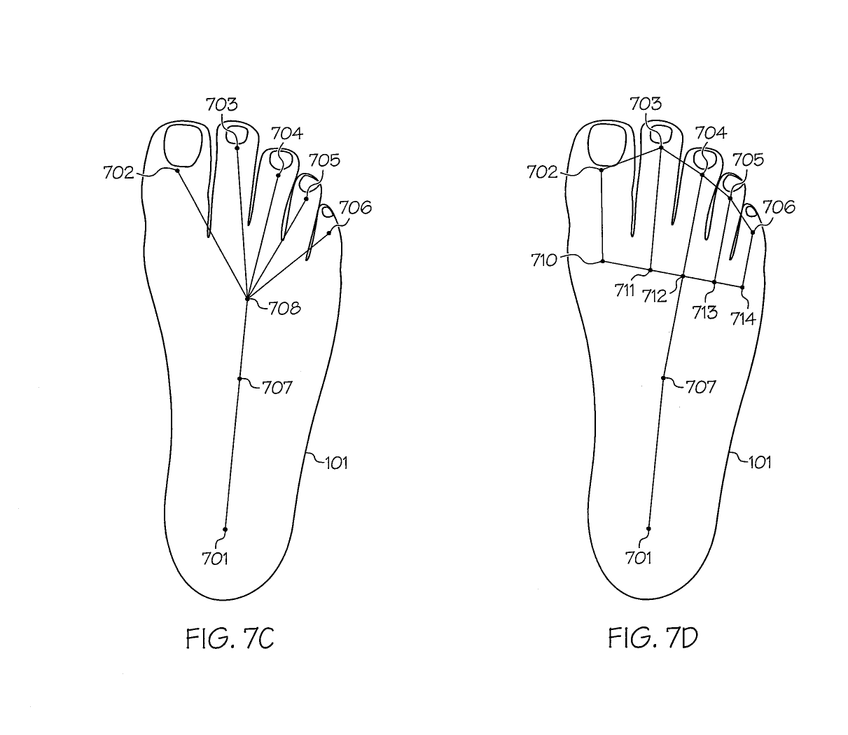

Still referring to FIG. 3, at block 315, the bare feet image may be processed to obtain one or more attributes of one or both feet. According to various embodiments, uneven distribution of the weight of the user may provide incorrect imaging of the shape of the feet and/or incorrect body fat measurements. Image processing may be used to determine the distribution of the weight between the first foot and the second foot. The distribution of weight may include a portion of the total weight of the user supported by the first foot and the portion of the total weight of the user supported by the second foot. If the weight is unevenly distributed between the two feet, an indication may be provided to the user. The weight may be determined to be unevenly distributed if a percentage of weight on either of the feet exceeds a threshold value. According to various embodiments, image processing may used on the image to determine structure points on the human foot such as the heel, toes, ball, sole, arch, and/or instep, in order to generate a stick figure representation of the foot. The stick figure representation of the foot may be used to generate measurements of the foot such as width at various points along the foot, length, spacing between toes, spacing between the heel and the ball of the foot, etc. These various attributes of the feet may be used to distinguish between different users and will be discussed in further detail with respect to FIGS. 7A to 7D. In some embodiments, the user may be instructed to place only one foot on the scale. Identification of the user may be accomplished based on an image of a single foot. In some embodiments, the only the user's left foot image may be captured and matched while in other embodiments, only the user's right foot image may be captured and matched.

Still referring to FIG. 3, at block 320, a determination may be made regarding whether one or more of the aforementioned attributes of the user on the weigh scale matches or closely approximates one or more of the provisioned users of the weigh scale. According to various embodiments, a combination of attributes such as a distance from the heel to ball of the foot and/or the width of the foot at the ball may be used to determine matching the user to one of the provisioned users. One or more of the attributes may be weighted differently to arrive at the determination of the matching provisioned user. For example, the distance from the heel to the ball of the foot may be weighted more heavily that the width of the foot at the ball of the foot. If a determination is made that the user matches a provisioned user, at block 325, the weight of the user may be stored in association with the provisioned user. According to various embodiments, if the user is determined to not match one or more of the provisioned users, the user may be prompted, at block 330, using the display 104 of FIG. 2, to enter identification information for creation of a new provisioned user entry. Identification information may include name, gender, age, estimated weight, height for use in Body Mass Index (BMI), and/or other identifying attributes. At block 335, the weight and the bare feet image information may be associated with the entered identification information and stored as a new provisioned user.

Still referring to FIG. 3, according to various embodiments, at block 340, the weight information may be analyzed based on historical data related to the provisioned user. Statistical analysis such as mean, mode, distribution, etc. of the weight information collected over different points in time may be conducted for a given user. Trends of changes in weight may be identified. According to various embodiments, the user may be alerted if the weight is above or below a threshold weight or if the weight changes by a threshold amount in a period of time. At block 345, the weight information may be analyzed with respect to the provisioned users of the weigh scale and/or across one or more groups of users of one or more weigh scales connected to a network. Group analysis of weight may be useful in determining trends for weight in a household, office, and/or geographical area. For example, the average weight of persons in a geographical area may be determined. According to various embodiments, weight may be averaged based on identification information such as gender, age, and/or height. The data analysis has been described herein in the context of weight as a non-limiting example. Similar data analysis may be provided for the shape of the users' feet, body fat, BMI, and/or other parameters. The analysis described at block 340 and 345 may be done by the processor 107 of FIG. 2 or by other components in the weigh scale. Additionally, according to various embodiments, the analysis described at block 340 and 345 may be done remotely from the scale by other appliances across a network in communication with the weigh scale 100 of FIG. 2.

Still referring to FIG. 3, at block 350, results of the data analysis may be provided to the user. The results of the data analysis may be presented on the display 104 of the weigh scale 100 of FIGS. 1 and 2. The results may include information including the user's measurements as well as an aggregation of other users' measurements and/or differences from an aggregation of the other users' measurements. The results may be presented in various formats including numerical, graphical, and diagram form. Significant variances is measurements such as, for example, an increase in 2 kilograms of weight, may trigger an alert to the user. The alert may be a visual alert sent to the display 104 of the weigh scale 100 FIGS. 1 and 2, an audible alert, or a vibration alert that triggers vibration of the weigh scale 100. According to various embodiments, the results may be presented to a user via an application on a computer, tablet, and/or mobile device such as a smartphone over a network such as the internet. For example, the results may be made available to a health application on a smartphone such as Sony Lifelog™ activity tracking application.

In some embodiments, an initialization procedure may be conducted to configure the user of the weigh scale 100. Identification information including name, gender, age, and/or other identifying attributes may be input into the weigh scale 100 to configure the user. In some embodiments, the initial configuration may not include the weight of the user.

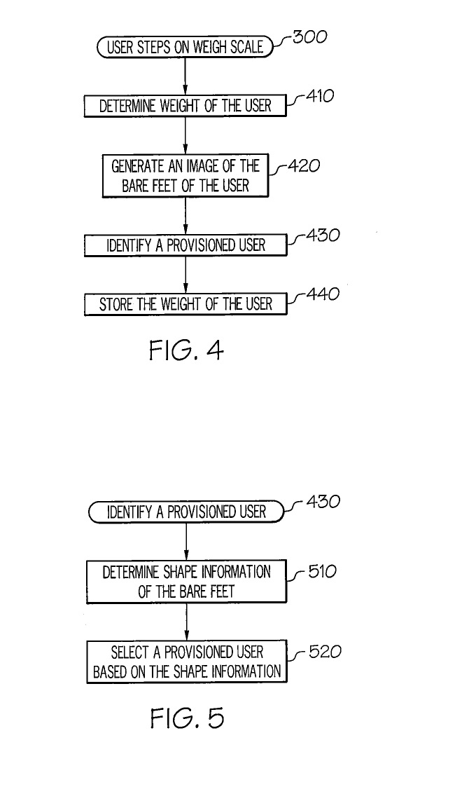

Referring to FIG. 4, a flowchart of operations that may be performed by the weigh scale 100 of FIGS. 1 and 2 is illustrated. These operations may correspond to operations discussed with respect to FIG. 3. The operations of FIG. 4 may be executed by any of the modules of FIG. 2 and may be stored in memory 105 of FIG. 2 to be executed by processor circuit 107 of FIG. 2. At block 300, a user may step on the weigh scale 100 of FIGS. 1 and 2. At block 410, the weight of the user may be determined by the weight sensor 102 of FIG. 2. At block 420, an image of the bare feet of the user may be generated. At block 430, a provisioned user may be identified based on the image of the bare feet and/or information related to provisioned users that is stored in a database. The information associated with the provisioned users may correspond to shape of the bare feet, orientation of a first foot and a second foot of the bare feet, the weight of the user, and/or body fat of the provisioned users. According to various embodiments, the provisioned user may be identified based on the weight and/or body fat of the user. According to various embodiments, orientation of a first foot and a second foot of the bare feet may be determined based on the image of the bare feet of the user. A provisioned user may be selected based on comparing the orientation information from the image of the bare feet of the user to previously stored orientation information associated with the provisioned users. At block 440, the weight of the user associated with the provisioned user may be stored.

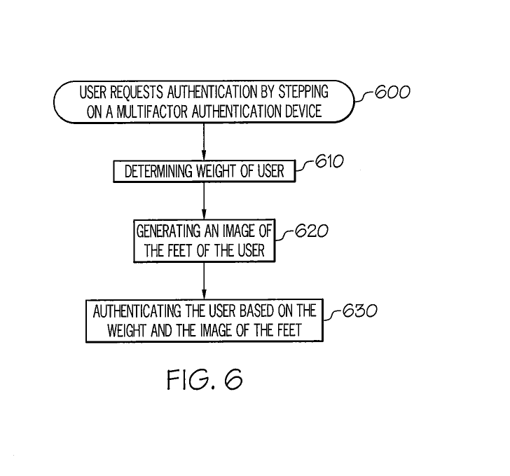

Referring now to FIG. 5, identifying a provisioned user at block 430 of FIG. 4 may include, at block 510, determining shape information of the bare feet. Determining shape information may include generating an outline of the bare feet. According to various embodiments, determining shape information may include applying image processing techniques to generate a stick figure image of the feet including structure points on each foot. These structure points on the foot may include the heel, toes, ball, sole, arch, and/or instep, in order to generate a stick figure representation of the foot. The stick figure representation of the foot may be used to generate measurements of the foot such as distances between various structure points. Additionally, according to various embodiments, the outline of the foot may be used in conjunction with the structure points on the foot to determine distances. For example, a distance from the structure point representing the heel to the back edge of the foot in the outline may be determined.

Still referring to FIG. 5, at block 520, the shape information may be used to select a provisioned user whose stored feet shape information matches or closely matches the shape of the feet of the user on the scale. According to various embodiments, the outline of the bare feet may be related to a grid and various grid points on the outline of the user's feet may be compared to those of a provisioned user. According to various embodiments, the measurements of the foot based on the structure points in the stick figure representation and/or the outline may be compared to those of a provisioned user to determine a match.

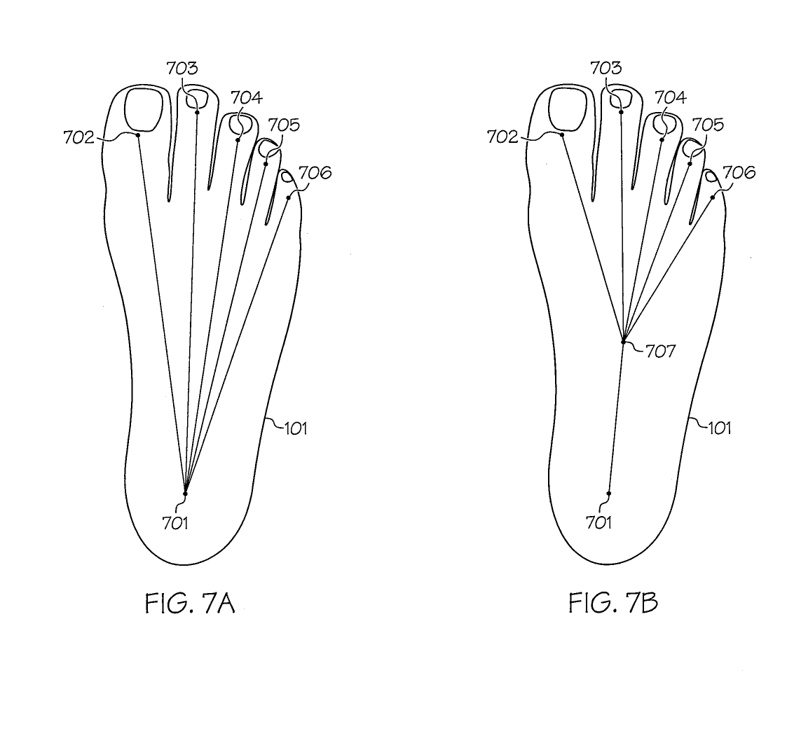

Embodiments discussed herein may use the image of the bare feet to identify the user to store the weight. Embodiments related to FIG. 6 may arise from the recognition that the image of the bare feet in conjunction with the weight of the user can provide a multifactor authentication for access to an electronic device such as a computer, access to a secure area, etc. Referring now to FIG. 6, at block 600, a user may request authentication by stepping on a multifactor authentication device. The multifactor authentication device may include the weigh scale 100 of FIGS. 1 and 2. According to various embodiments, the multifactor authentication device may include a housing with a first face on a horizontal surface of the housing and a second face on a horizontal surface of the housing, with the second face opposing the first face. The weight sensor 102 of FIG. 2 may be in the housing between the first face and the second face of the housing. The bare feet image sensor 103 of FIG. 2 may be on the first face of the housing. At block 610, the weight of the user may be determined by the weight sensor 102 of FIG. 2. At block 620, an image of the bare feet of the user may be generated. At block 630, a user may be authenticated based on the image of the bare feet. According to various embodiments, the provisioned user may be identified and/or authenticated based on the weight, image of the bare feet, and/or body fat of the user. Authentication by the multifactor authentication device may be part of a security system. According to various embodiments, authentication may provide the user access to a device such as a computer console, control terminal, and/or other electronic devices. According to various embodiments, authentication may provide the user access to a secure area by verifying the user's identity. Access to a secure area may be gained by unlocking, opening, or otherwise providing access to a secure door, a shielding structure, a controller for a door, and/or a safe based on the authentication of the user.

FIGS. 7A to 7D illustrate various techniques that can be used to process the image of the bare feet described with respect to block 315 of FIG. 3, block 510 of FIG. 5, and/or block 630 of FIG. 6 by using stick figure representations of the foot including structure points. Referring now to FIG. 7A, the bare feet image sensor 103 and/or processor 107 may determine the location of structure point 701 corresponding to the heel of the foot 101. Structure points 702 to 706 may represent the location of the toes of foot 101. Information regarding the shape of the foot 101 may include distance measurements between structure point 701 corresponding to the heel and each of the structure points 702 to 706 corresponding to the toes. Referring now to FIG. 7B, a structure point 707 may represent the location of the arch of the foot 101. Distance measurements between structure point 707 corresponding to the arch and each of the structure points 702 to 706 corresponding to the toes may be determined. Referring now to FIG. 7C, a structure point 708 may represent the location of the ball of the foot 101. Distance measurements between structure point 707 corresponding to the arch and structure point 708 corresponding to the ball of the foot may be made. Likewise, distance measurements between structure point 707 corresponding to the arch and each of the structure points 702 to 706 corresponding to the toes may be determined. Referring now to FIG. 7D, structure points 710 to 714 along the ball of the foot 101, aligned with respective corresponding toes may be determined. Distance measurements between structure points 710 to 714 along the ball of the foot and respective structure points 702 to 706 corresponding to the toes may be determined. According to various embodiments, the distance between adjacent toes, such as, for example, between structure points 702 and 703 may be determined. One or more of the aforementioned distance measurements and/or other techniques may be used in determining the shape of the foot 101.

### Further Definitions and Embodiments

In the above-description of various embodiments of the present inventive concepts, aspects of the present inventive concepts may be illustrated and described herein in any of a number of patentable classes or contexts including any new and useful process, machine, manufacture, or composition of matter, or any new and useful improvement thereof Accordingly, aspects of the present inventive concepts may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present inventive concepts may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present inventive concepts may be written in any combination of one or more programming languages, including an object oriented programming language such as Java, Scala, Smalltalk, Eiffel, JADE, Emerald, C++, C#, VB.NET, Python, etc., conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the device, partly on the device, as a stand-alone software package, partly on the device and partly on a remote computer or entirely on the remote computer or server. In the latter scenario, the remote computer may be connected to the device through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present inventive concepts are described herein with reference to flowchart illustrations and/or block diagrams of methods, apparatus (device), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the terminology used herein is for the purpose of describing particular embodiments only and is not intended to be limiting to other embodiments. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the Figures illustrate the architecture, functionality, and operation of possible implementations of systems, methods, and computer program products according to various aspects of the present inventive concepts. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Spatially relative terms, such as “beneath,” “below,” “lower,” “above,” “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the Figures.

The corresponding structures, materials, acts, and equivalents of any means or step plus function elements in the claims below are intended to include any disclosed structure, material, or act for performing the function in combination with other claimed elements as specifically claimed. The description of the present inventive concepts has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A device for weighing a user, the device comprising:
a weight sensor configured to determine a weight of the user;
a bare feet image sensor configured to generate an image of the bare feet of the user;
a database configured to store information associated with an image of the bare feet of one or more provisioned users of the device; and
a processor that is responsive to the weight sensor and to the bare feet image sensor and is configured to execute computer program instructions to perform operations comprising:
identifying a provisioned user out of the one or more provisioned users in the database based on the image of the bare feet of the user; and
storing the weight of the user associated with the provisioned user in the database.

2. The device of claim 1, wherein the identifying the provisioned user is further based on the weight of the user.

3. The device of claim 1, further comprising:
a body fat measurement sensor configured to determine body fat of the user,
wherein the identifying the provisioned user comprises identifying the provisioned user out of the one or more provisioned users based on the image of the bare feet of the user, the weight of the user, and the body fat of the user.

4. The device of claim 1, wherein the bare feet image sensor comprises a capacitive touch-sensitive sensor on the weight sensor.

5. The device of claim 4, further comprising:
a display,
wherein the capacitive touch-sensitive sensor at least partially overlaps the weight sensor and does not overlap the display.

6. The device of claim 1, wherein the bare feet image sensor provides a notification to the user in response to determining that bare feet of the user are not properly positioned on the bare feet image sensor.

7. The device of claim 1, further comprising:
determining a distribution of the weight comprising a first portion of the weight on a first foot and a second portion of the weight on a second foot of the bare feet of the user; and
providing an indication to the user in response to a difference in the first portion and the second portion of the weight exceeding a threshold.

8. The device of claim 7, wherein the distribution of the weight is based on information from the weight sensor and information from the bare feet image sensor.

9. The device of claim 1, wherein the information associated with the one or more provisioned users of the device comprises a stored information associated with a respective one of the one or more provisioned users corresponding to a shape of the bare feet, an orientation of a first foot and a second foot of the bare feet, a weight of the user, and/or a body fat of the respective one of the one or more provisioned users.

10. The device of claim 9, wherein the identifying a provisioned user out of the one or more provisioned users based on the image of the bare feet of the user comprises:
determining shape information corresponding to a shape of the bare feet of the user based on the image of the bare feet; and
selecting a provisioned user based on a comparison of the shape information and the stored information.

11. The device of claim 9, wherein the identifying a provisioned user out of the one or more provisioned users based on the image of the bare feet of the user comprises:
determining an orientation information of a first foot and a second foot of the bare feet based on the image of the bare feet of the user; and
selecting a provisioned user based on a comparison of the orientation information and the stored information.

12. The device of claim 1, wherein the device comprises a weigh scale.

13. The device of claim 1, further comprising:
an internet communication circuit configured to provide communication network connectivity between the device and an Internet of Things (IoT) network.

14. The device of claim 1, wherein the user comprises a human being, a cat, a dog, or other living thing.

15. A multifactor authentication device for authenticating a user of an electronic device, the multifactor authentication device comprising:
a weight sensor configured to determine a weight of the user;
a bare feet image sensor configured to generate an image of the bare feet of the user on the multifactor authentication device;
a database configured to store information associated with an image of the bare feet of a plurality of provisioned users; and
a processor that is responsive to the weight sensor and to the bare feet image sensor and is configured to execute computer program instructions to perform operations comprising:
authenticating the user to access the electronic device based on the weight of the user and the image of the bare feet of the user on the multifactor authentication device.

16. The multifactor authentication device of claim 15, further comprising:
a body fat measurement sensor configured to determine body fat of the user on the multifactor authentication device,
wherein the authenticating the user comprises authenticating the user based on the image of the bare feet of the user, the weight of the user, and the body fat of the user.

17. The multifactor authentication device of claim 15, further comprising:
a housing comprising a first face and a second face opposing the first face,
wherein the first face is configured for placement on a horizontal surface;
wherein the weight sensor is in the housing between the first face and the second face, and
wherein the bare feet image sensor is on the second face of the housing.

18. A method for weighing a user on a weigh scale, the method comprising:
determining a weight of the user;
generating an image of bare feet of the user on the weigh scale;
identifying a provisioned user out of one or more provisioned users, based on the image of the bare feet of the user on the weigh scale and information stored in a database that is associated with an image of the bare feet of the one or more provisioned users of the weigh scale; and
storing the weight of the user associated with the provisioned user.

19. The method of claim 18, the method further comprising:
determining a distribution of the weight comprising a first portion of the weight on a first foot and a second portion of the weight on a second foot of the bare feet of the user; and
providing an indication to the user in response to a difference in the first portion and the second portion of the weight exceeding a threshold.

20. The method of claim 18, wherein the information stored in the database comprises a stored information associated with a respective one of the one or more provisioned users corresponding to a shape of the bare feet, a weight of the user, and/or a body fat of the respective one of the one or more provisioned users.

21. The method of claim 20, wherein the identifying a provisioned user out of the one or more provisioned users based on the image of the bare feet of the user on the weigh scale comprises:
determining shape information corresponding to a shape of the bare feet of the user based on the image of the bare feet; and
selecting a provisioned user based on a comparison of the shape information and the stored information.
